(19) United States
(12) Patent Application Publication
(10) Pub. No.: US 2009/0308328 A1
(43) Pub. Date: Dec. 17, 2009

(54) PET AMUSEMENT TOY

(76) Inventors: Michael Kellogg, Oconomowoc, WI (US); RoseMary L. Overton, Waukesha, WI (US); Dean B. Krotts, Hartland, WI (US); Adam M. Kellogg, Oconomowoc, WI (US); Yin-Kai Kelly Cheng, Oconomowoc, WI (US)

Correspondence Address: ZIOLKOWSKI PATENT SOLUTIONS GROUP, SC (ZPS), 136 S WISCONSIN ST, PORT WASHINGTON, WI, 53074, US

(21) Appl. No.: 12/137,003

(22) Filed: Jun. 11, 2008

(51) Int. Cl. A01K 29/00; A01K 15/02

(52) U.S. Cl. 119/706; 119/707; 29/592

(57) ABSTRACT

A system and method for enticing pet play includes a pet amusement device having an arch-shaped rocking platform and a member attached to the rocking platform that has a track formed therein. The track, which is not a closed loop, extends from a first end of the member to a second end of the member. Engaged with the member is a moveable object that may move along the track that is formed therein.

### BACKGROUND OF THE INVENTION

The present invention relates generally to pet amusement toys and devices, and, more specifically, to a rocking toy that includes a moveable part of the toy to entice pet play when a rocking-like motion is induced in the toy.

There is a wide variety of pet amusement devices designed for the amusement of pets. Often, these amusement devices contain moveable objects that elicit the prey instinct in cats or other pets; therefore, pets treat these moveable objects as objects of prey. As such, the cat or other pet is enticed to play with such amusement devices.

Many of the toys known in the art often require, or at least work best with, human interaction. For example, one such cat amusement device consists of a stick, string, and an object. One end of the string is connected to one end of the stick. The other end of the string is connected to an object. Often the object is a small ball or a small furry piece of material. A person, by shaking the stick at the end opposite the string, induces the object to move in an erratic motion. Such motion then elicits the prey instinct in a cat, causing the cat to play with or attack the object.

Other pet amusement toys are constructed in such a manner as to not necessitate human interaction for a pet to enjoy the full amusement potential of the toy. For example, tracks containing balls, or other moveable objects, are seen throughout the art of pet amusement devices. Many of these devices consist of a circular track and a ball contained by the track, the ball being able to move within the confines of the circular track. The circular track lays flat on the ground and the pet, such as a cat, is able to gain access to the ball from the top, or even the sides, of the track. Though the cat is able to gain access to the ball in such devices, the devices are constructed in such a manner as to not allow the cat to remove the ball from the track. Therefore, the cat is able to swat at the ball and cause the ball to move within the track. In a broad sense, the cat is able to induce the ball into motion in two ways. First, the cat may induce the ball into motion by applying direct and constant contact to the ball, causing the ball to move as long as the cat's paw remains in direct and constant contact with the ball. Second, the cat may merely briefly apply a force to the ball, causing the ball to move under its own inertia. In either manner of inducing the ball to move, pet-ball contact is required.

Other circular track-type pet toys allow for a slight track motion. That is, in addition to allowing ball movement within a track, such devices also allow for the pet to induce a slight motion into the track. Such devices are often circular in shape to accommodate the continuous circular track which is incorporated therein. Further, these toys are constructed in a manner such that they are not stable when placed on a flat surface. That is, though the top surface of such toys are flat, the bottoms of such toys are often uneven, allowing the toy to be slightly tipped when a pet, such as a cat, makes contact with or otherwise applies a pressure to the circular base or track of the unit. The tipping then causes the ball to move through the circular track. The magnitude or degree to which such devices may be tipped is slight, and as such, is likely to go unnoticed by the pet.

Electric powered cat toys also do not require human interaction for the pet to enjoy the full amusement benefit of the device. For example, instead of the cat or other pet inducing the ball or object to move, an electric motor provides motive power that is used to induce the object to move. Such devices require batteries or another electric power source.

The devices mentioned above that do not require human interaction, however, largely rely only on ball or object motion within a circular track to entice a cat or other pet to play. Other manners of enticing pets, such as cats, to play have remained largely unexplored.

It would therefore be desirable to have a system and method capable of enticing cats or other pets to play by inducing motion into an object of prey.

### BRIEF DESCRIPTION OF THE INVENTION

Embodiments of the present invention provide a system and method of enticing a pet to play.

In accordance with one aspect of the invention, a pet amusement device includes an arch-shaped rocking platform and a member attached to the rocking platform that has a track formed therein. The track, which is not a closed loop, extends from a first end of the member to a second end of the member. Engaged with the member is a moveable object that may move along the track that is formed therein.

In accordance with another aspect of the invention, a rocking structure configured to move in a rocking pattern when a pet moves thereon includes a first arc-shaped support having a track that has a first end and a second end, a second arch-shaped support, an object moveably engaged with the track, and a platform connected to and spanning the first and second arc-shaped supports. The moveable object is configured to move along the track from the first end to the second end.

In accordance with another aspect of the invention, a method of manufacturing a pet amusement device includes forming an arcuate platform and coupling a non-continuous track to the arcuate platform such that an object is guided along the non-continuous track when the arcuate platform is induced to rock.

In accordance with yet another aspect of the invention, a pet amusement apparatus includes a rocking structure having a rocking axis of rotation and a track configured to support an object such that the object moves along a path defined by the track. The track, a majority of which lies in an imaginary plane, is attached to the rocking structure such that an angle between the rocking axis of rotation and an axis perpendicular to the imaginary plane is less than 90 degrees.

Various other features and advantages of the present invention will be made apparent from the following detailed description and the drawings.

### BRIEF DESCRIPTION OF THE DRAWINGS

The drawings illustrate several embodiments of the invention.

In the drawings:

FIG. 1 is a perspective view of a pet amusement device according to an embodiment.

FIG. 2 is a perspective view of a rocking structure or pet toy according to an embodiment.

FIG. 3 is a perspective view of a pet amusement device according to an embodiment.

FIG. 4 is a perspective view of an orientation of a track according to an embodiment.

FIG. 5 is a perspective view of an alternate orientation of a track according to an embodiment.

FIG. 6 is a perspective view of an alternate member, track, and moveable object according to an embodiment.

FIG. 7 is a perspective view of another alternate member, track, and moveable object according to an embodiment.

### DETAILED DESCRIPTION OF THE PREFERRED EMBODIMENT

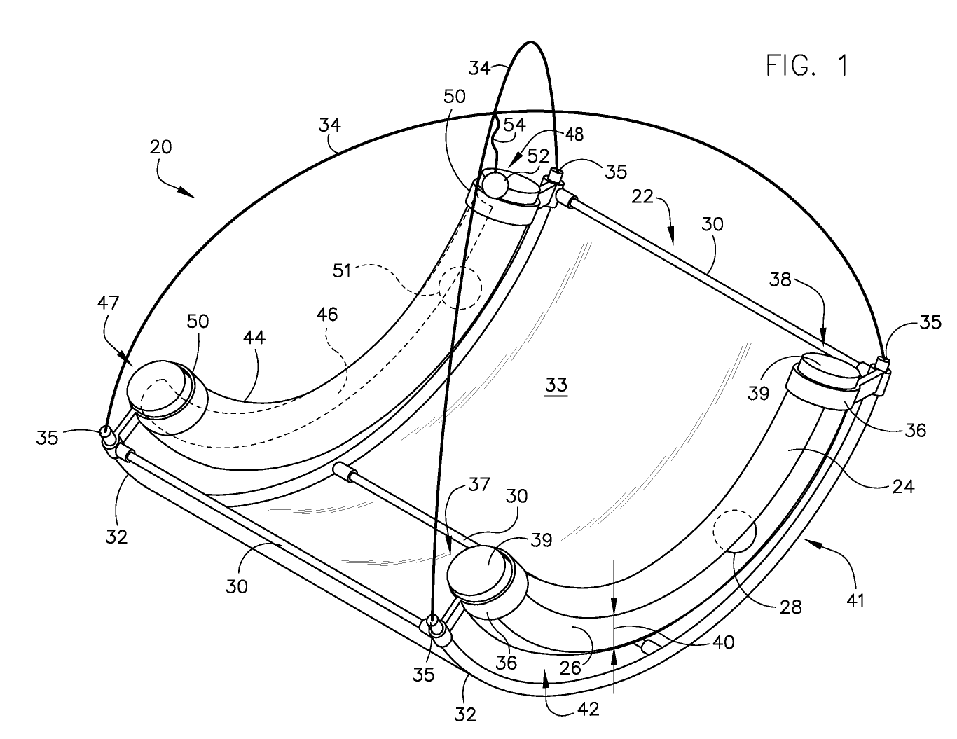

An apparatus and method are set forth for enticing a cat or other pet into play and/or exercise. Referring to FIG. 1, a rocking pet toy 20 according to an embodiment of the invention is shown. Pet toy 20 includes an arch-shaped rocking platform 22 having a member 24 attached thereto. In a preferred embodiment, member 24 is an arch-shaped member. Other shapes are contemplated, however, and will be discussed below (see, for example, FIG. 7). Formed within member 24 is a track 26 that holds a moveable object 28. As such, moveable object 28 is engaged with member 24. Accordingly, a pet may induce moveable object 28 into motion either with contact to moveable object 28 by, for example, a paw or by inducing a rocking-like motion into rocking pet toy 20.

Arch-shaped platform 22 includes a plurality of cross supports 30 attached to a pair of edge supports 32. A base 33 is attached to edge and cross supports 30, 32. According to an embodiment of the invention, platform 22 is flexible and, in a relaxed state, is substantially planar. To form the arched shape, platform 22 is flexed, and a pair of cross-members 34 are inserted into endpoints 35 of edge supports 32. Cross-members 34 may be rigid or flexible. According to another embodiment, either or both of edge supports 32 or base 33 are rigid such that the arched shape of platform 22 is therefrom.

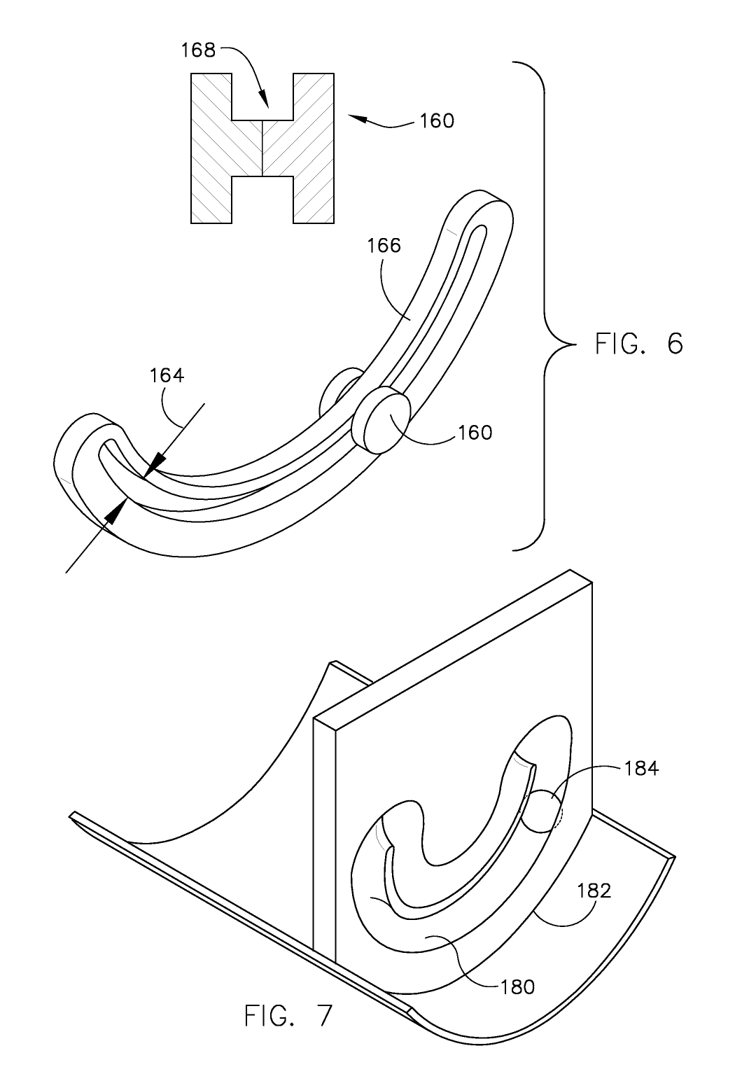

Arch-shaped member 24 is coupled to platform 22 by a pair of connectors 36. As shown, track 26, which is formed in arch-shaped member 24, extends from a first end 37 of arch-shaped member 24 to a second end 38 of arch-shaped member 24 such that track 26 is a non-continuous track. A pair of end caps 39 are attached to first and second ends 37, 38 of arch-shaped member 24 to keep moveable object 28 within track 26. As shown, moveable object 28 is a ball rollingly engageable with track 26. However, it is contemplated that other types of moveable objects that can be held by a track may also function in a manner to induce pet play or interaction consistent with embodiments of the invention. Further examples of moveable objects that may be rollingly or slidingly engageable with member 24 are discussed hereinbelow with respect to FIGS. 6 and 7.

Still referring to FIG. 1, a slot or opening 40 is formed in arch-shaped member 24. Slot 40 allows a pet to gain access to the moveable object 28 from a side 41 of arch-shaped member 24. While slot 40 is shown to be formed on the side 41 of arch-shaped member 24, it is contemplated that slot 40 could be formed or created in other positions in arch-shaped member 24. For example, slot 40 could be formed on a top or on an inside portion of arch-shaped member 24. It is also contemplated that more than one slot 40 may be formed in arch-shaped member 24. A gap 42 may be formed between arch-shaped member 24 and platform 22 such that a pet that is positioned on platform 22 may gain access to the ball 28 from below arch-shaped member 24 as well as above. That is, a pet, such as a cat, that is positioned on the platform 22 may reach through gap 42 to make contact with moveable object 28.

According to an embodiment of the invention, pet amusement toy 20 may include more than one arch-shaped member 24. For example, as shown in phantom, an additional arch-shaped member 44 may be attached or coupled to the platform 22. As with the first member 24, the additional arch-shaped member 44 could also have a non-continuous track 46 (shown in phantom) formed or created therein. Similar to track 26 shown formed within first arch-shaped member 24, track 46 may extend between first and second ends 47, 48 of additional member 44. As such, a moveable object 51 engaged with the additional arch-shaped member 44 may move along track 46 of additional arch-shaped member 44 from the first end 47 to the second end 48. As shown, additional member 44 may be attached or coupled to the arch-shaped platform 22 by a pair of connectors 50.

One or more of cross-members 34 may be used to support a pet enticement object 52 for further enticement of pet play. For example, as shown in FIG. 1, a pet enticement object 52 may be connected to one or more of the cross-members 34 by a string or other material 54. For example, in one embodiment, object 52 could be filled or covered with cat-nip. In another exemplary embodiment, object 52 may be made of some type of furry or furry-like material. As such, object 52 may entice the cat or other pet to enter upon the arch-shaped platform 22, thus inducing motion into the platform 22 and, accordingly, into moveable object 28 held by track 24. Cross-members 34 allow for the placement of multiple objects 52 along lengths thereof, and each object 52 could contain an item such as cat-nip or a bell to further entice a pet into play.

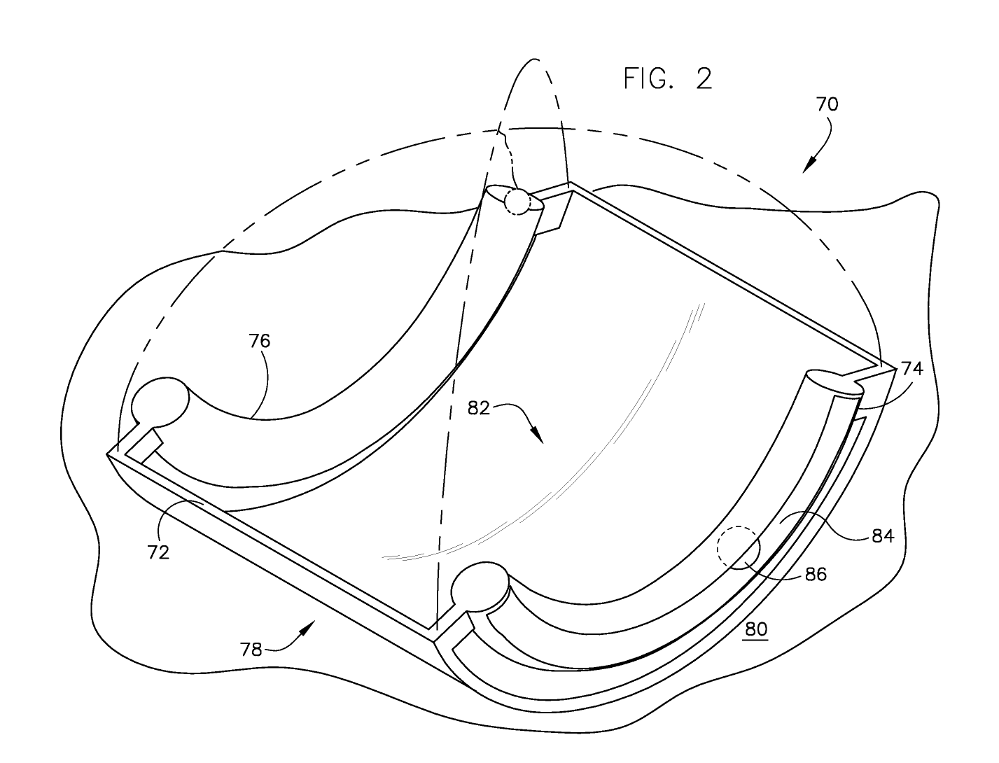

FIG. 2 shows a rocking structure 70 according to another embodiment of the present invention. Rocking structure 70 is a single unit that includes a platform 72 having a pair of members or rockers 74, 76. That is, rather than attaching members 74, 76 to the platform 72 after each has been individually formed, rocking structure 70 could be manufactured in such a manner that the platform 72 and members 74, 76 are one piece. As shown, the rocking structure has a curved bottom surface 78 that makes contact with a floor 80 or other support surface and a top surface 82 that is also curved. As with other embodiments described herein, members 74, 76 may each contain a track 84 formed therein. Further, a ball or other moveable object 86 may be held by each track 84 such that ball 86 is able to move freely within the confines of track 84. In addition, though only one ball 86 is shown, it is contemplated that more than one ball or moveable object 86 could be held by, or placed within, each 84. Ball 86 may be induced to move either by inducing movement in rocking structure 70 in a rocking-like manner or by direct contact with ball 86.

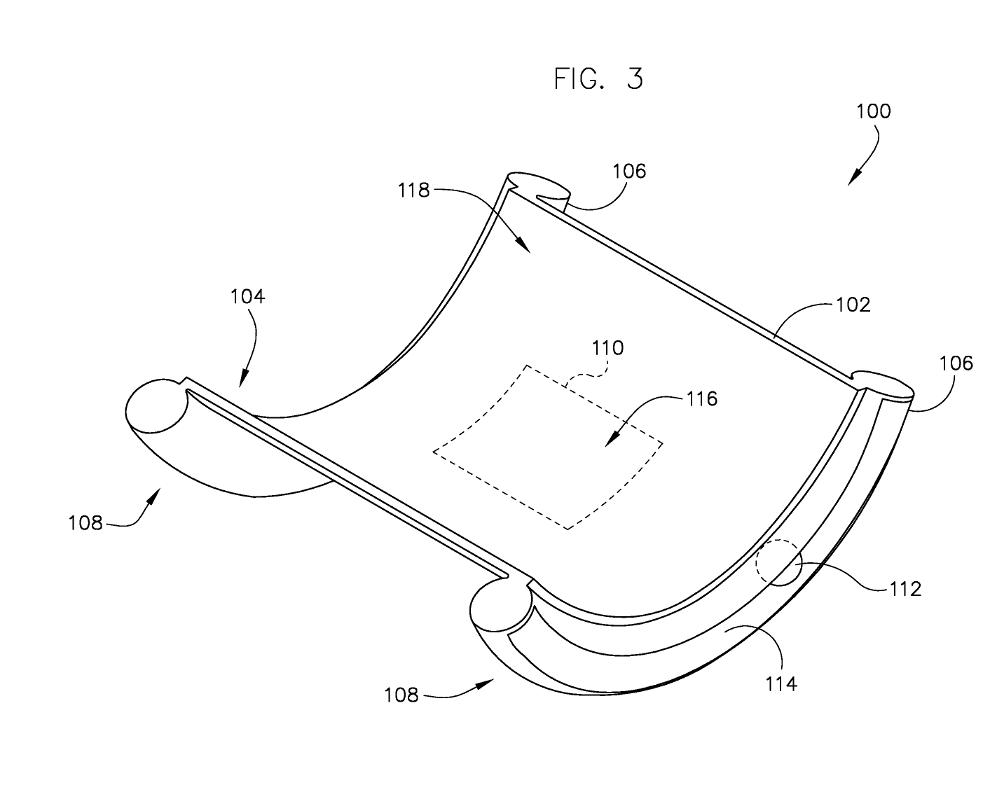

FIG. 3 shows an alternate embodiment of the rocking structure shown in FIG. 2 As shown, a rocking structure 100 includes an arcuate platform 102 formed on a top 104 of a pair of arch-shaped supports 106. In this manner, supports 106, rather than platform 102, serve as rockers for rocking structure 100. Though FIG. 3 depicts platform 102 formed on top of supports 106, it is contemplated that platform 102 could be formed or coupled to supports 106 at any location above the bottom 108 of supports 106.

Still referring to FIG. 3, as shown in phantom, it is contemplated that a scratching pad 110 could be formed or coupled to platform 102. As such, scratching pad 110 could further induce a cat or other pet to enter upon rocking structure 100, thus causing moveable object 112 to move along track 114. While, as shown, scratching pad 110 has a surface area 116 less than the surface area 118 of the platform 102, it is contemplated that scratching pad 110 could have a surface area equal to or greater than the surface area 118 of the platform 102.

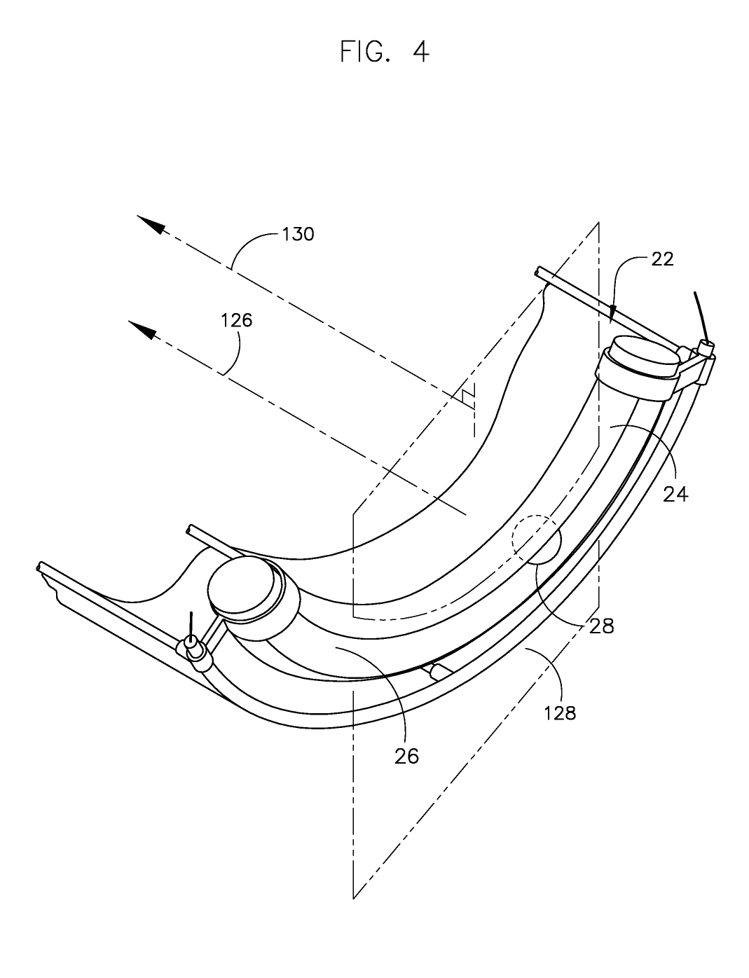

FIG. 4 shows a portion of pet toy 20 discussed above with respect to FIG. 1. A rocking axis of rotation 126, FIG. 4, is shown about which arch-shaped rocking platform 22 of pet toy rotates or rocks as rocking motion is induced thereon. Also shown, is an imaginary plane 128 that encompasses a majority of track 26 formed or manufactured into member 24. As shown, member 24 is attached to platform 22 such that a normal or perpendicular line 130 to imaginary plane 128 is at a non-perpendicular angle with respect to rocking axis of rotation 126. In particular, FIG. 4 depicts track 26 orientated such that line 130 perpendicular to the imaginary plane 128 is substantially parallel to rocking axis of rotation 126. Accordingly, since rocking axis of rotation 126 is parallel to a support surface (not shown), perpendicular line 130 is substantially parallel to support surface (not shown). In this manner, moveable object 28 is caused to move along track 26 for each change in rocking position. Accordingly, a pet entering, or otherwise inducing motion to, platform 22 may induce motion to the moveable object 28 therefrom.

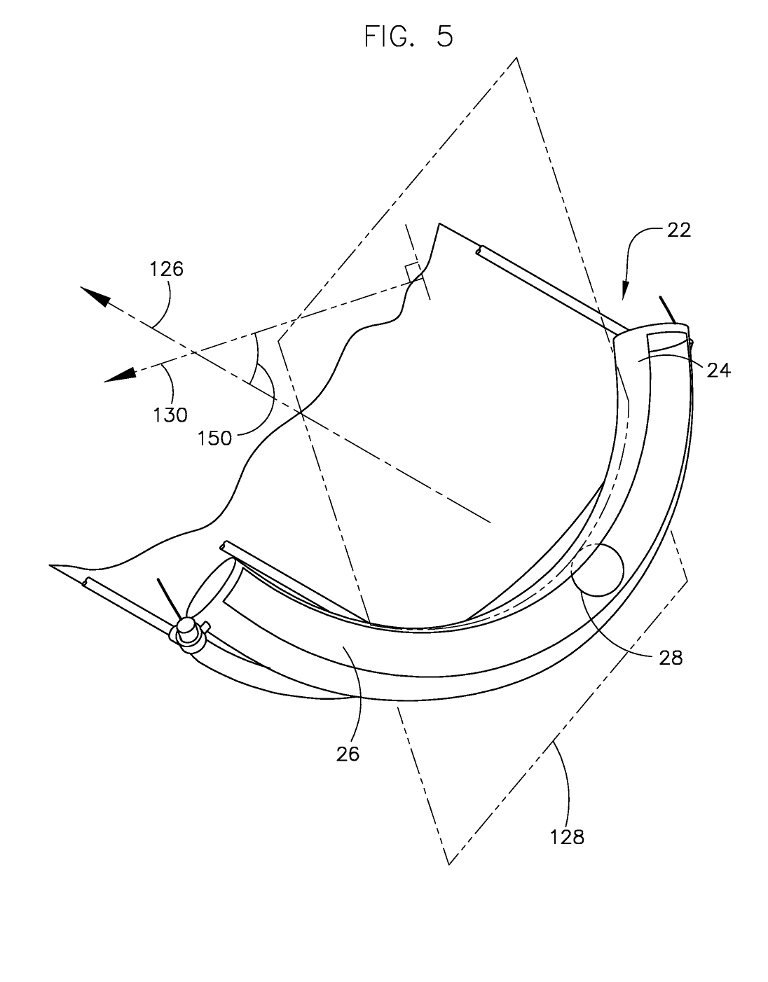

FIG. 5 shows an alternative orientation of track 26 to that shown in FIG. 4. As shown in FIG. 5, member 24 is oriented such that line 130, which is perpendicular to imaginary plane 128 encompassing a majority of track 26, is at a non-perpendicular, non-parallel angle 150 with respect to rocking axis of rotation 126. In this manner, member 24 may be attached to a non-rectangular-shaped platform (not shown) and maintain the benefit of allowing moveable object 28 to move along track 26 for each change in rocking position as described above.

FIG. 6 depicts a member and moveable object that may be employed in embodiments of the invention. A dumbbell-shaped moveable object 160 held by a track 164, which is formed into member 166, is shown. A central portion 168 of dumbbell-shaped object 160 is rollingly or slideably engageable with track 164, which guides object 160 therealong.

Referring now to FIG. 7, a member, track, and moveable object are shown according to an embodiment of the invention. In contrast to other embodiments depicted, track 180 that is formed or manufactured in member 182 has a circuitous path or closed loop such that track 180 does not have a first and second end that terminate the path. In this manner, a pet, such as a cat, may find it difficult to trap a movable object 184, such as a disk, in track 180 with a single paw. Further, as shown, member 182 is not arch-shaped. Rather, in the present embodiment member 182 has a rectangular box-like shape. A variety of member shapes are contemplated, where each includes at least one track and at least one moveable object.

In accordance with an embodiment, a pet amusement device includes an arch-shaped rocking platform and a member attached to the rocking platform that has a track formed therein. The track, which is not a closed loop, extends from a first end of the member to a second end of the member. Engaged with the member is a moveable object that may move along the track that is formed therein.

In accordance with another embodiment, a rocking structure configured to move in a rocking pattern when a pet moves thereon includes a first arc-shaped support having a track that has a first end and a second end, a second arch-shaped support, an object moveably engaged with the track, and a platform connected to and spanning the first and second arc-shaped supports. The moveable object is configured to move along the track from the first end to the second end.

In accordance with another embodiment, a method of manufacturing a pet amusement device includes forming an arcuate platform and coupling a non-continuous track to the arcuate platform such that an object is guided along the non-continuous track when the arcuate platform is induced to rock.

In accordance with yet another embodiment, a pet amusement apparatus includes a rocking structure having a rocking axis of rotation and a track configured to support an object such that the object moves along a path defined by the track. The track, a majority of which lies in an imaginary plane, is attached to the rocking structure such that an angle between the rocking axis of rotation and an axis perpendicular to the imaginary plane is less than 90 degrees.

The present invention has been described in terms of the preferred embodiment, and it is recognized that equivalents, alternatives, and modifications, aside from those expressly stated, are possible and within the scope of the appending claims.

What is claimed is:

1. A pet amusement device comprising:
an arch-shaped rocking platform;
a member attached to the rocking platform and having a track formed therein, the track extending from a first end of the member to a second end of the member, wherein the track is not a closed loop; and
a moveable object engaged with the member such that the moveable object moves along the track.

2. The pet amusement device of claim 1 wherein the member is an arch-shaped member.

3. The pet amusement device of claim 1 further comprising a second member attached to the rocking platform and having a second track formed therein, the second track extending from a first end of the second member to a second end of the second member.

4. The pet amusement device of claim 1 wherein the platform has a first surface that is generally arch shaped and a second surface opposite the first surface that is generally arch shaped.

5. The pet amusement device a claim 1 wherein the track is a closed loop.

6. The pet amusement device of claim 1 wherein the moveable object is generally spherical shaped.

7. The pet amusement device of claim 1 wherein the moveable object is generally dumbbell shaped.

8. The pet amusement device of claim 1 wherein a majority of the track lies on an imaginary plane, and wherein the imaginary planes is generally non-parallel to a surface that supports the rocking structure.

9. The pet amusement device of claim 1 further comprising a pet enticement object attached to the rocking structure

10. A rocking structure configured to move in a rocking pattern when a pet moves thereon, the rocking structure comprising:
a first arc-shaped support having a track, wherein the track has a first end and a second end;
an object moveably engaged with the track, wherein the object is configured to move along the track between the first and second end;
a second arch-shaped support; and
a platform connected to and spanning the first and second arc-shaped supports.

11. The rocking structure of claim 10 wherein the second arc-shaped support has a second track, wherein the second track has a first end and a second end.

12. The rocking structure of claim 10 wherein the object moveably engaged with the track is generally disk shaped.

13. The rocking structure of claim 10 further comprising a scratching pad coupled to the platform.

14. The rocking structure of claim 10 wherein the rocking structure has a first surface that makes contact with a support surface that supports the rocking structure, and wherein the rocking structure has a second surface opposite the first surface that is arch shaped.

15. A method of manufacturing a pet amusement device comprising:
forming an arcuate platform;
coupling a non-continuous track to the arcuate platform such that an object is guided along the non-continuous track when the arcuate platform is induced to rock.

16. The method of claim 15 further comprising coupling a second non-continuous track to the arcuate platform such that a second object is guided along the second non-continuous track when the arcuate platform is induced to rock.

17. The method of claim 15 wherein the arcuate platform has a surface that a pet enters upon, and wherein the surface is arcuate shaped.

18. A pet amusement apparatus comprising:
a rocking structure having a rocking axis of rotation;
a track configured to support an object such that the object moves along a path defined by the track, wherein at least a majority of the path lies on an imaginary plane; and
wherein the track is attached to the rocking structure such that an angle between the rocking axis of rotation and an axis perpendicular to the imaginary plane is less than 90 degrees.

19. The pet amusement apparatus of claim 18 wherein the axis perpendicular to the imaginary plane is parallel to the rocking axis of rotation.

20. The pet amusement apparatus of claim 18 wherein the path is a closed loop.

21. The pet amusement apparatus of claim 18 wherein the defined path has a first end and a second end.
